(19) United States
(12) Patent Application Publication
(10) Pub. No.: US 2012/0304147 A1
(43) Pub. Date: Nov. 29, 2012

(54) Method of Application State Flow Control in Telco Application Store

(76) Inventor: Ju-Ting Yang, Taoyuan County (TW)

(21) Appl. No.: 13/445,845

(22) Filed: Apr. 12, 2012

Related U.S. Application Data
(60) Provisional application No. 61/490,611, filed on May 27, 2011.

(30) Foreign Application Priority Data
Feb. 3, 2012 (TW) 101103518

(51) Int. Cl. G06F 9/44

(52) U.S. Cl. 717/100

(57) ABSTRACT

A method of application state flow control for a developer support in Telco's application store includes transferring a state of an application between offline, online, submitted, audited, tested and end states according to an operation corresponding to the application and an application developer, wherein the operation includes at least one of upload procedure, audited procedure, delete or revocation procedure, test procedure, registration procedure, and de-registration procedure.

### CROSS REFERENCE TO RELATED APPLICATIONS

This application claims the benefit of U.S. Provisional Application No. 61/490,611, filed on May 27, 2011 and entitled “Application State Flow Control in TAS (Telco's Application Store)”, the contents of which are incorporated herein in their entirety.

### BACKGROUND OF THE INVENTION

1. Field of the Invention

The present invention relates to a method utilized in Telco's application store (TAS), and more particularly, to a method of application state flow control in TAS.

2. Description of the Prior Art

Open Mobile Alliance (OMA) is founded to develop OMA specifications for mobile services to meet users' needs. Furthermore, the OMA specifications aim to provide the mobile services which are interoperable across geographic areas (e.g. countries), operators, service providers, networks, operation systems and mobile devices. In detail, the mobile services conforming to the OMA specifications can be used by the users without restriction to particular operators and service providers. The mobile services conforming to the OMA specifications are also bearer agnostic, i.e., the bearer that carries the mobile services can be a second generation (2G) mobile system such as Global System for Mobile Communications (GSM), Enhanced Data rates for GSM Evolution (EDGE) or General Packet Radio Service (GPRS), or a third generation (3G) and beyond mobile system such as Universal Mobile Telecommunications System (UMTS), Long Term Evolution (LTE) or LTE-Advanced (LTE-A). Further, the mobile services can be executed on an operation system such as Windows, Android or Linux operated on various mobile devices. Therefore, industries providing devices or the mobile services supporting the OMA specifications can benefit from a largely growing market enabled by interoperability of the mobile services. Besides, the users use the devices or the mobile services supporting the OMA specifications can also have a better experience due to the interoperability of the mobile services.

In addition, Telco's application store (TAS) with a unified architecture conforming to the OMA specifications is designed for specifying development, support, classification and sale of applications. The TAS attracts developers and community organizations developing the applications by creating an application platform. Besides, please refer to FIG. 1, which is a schematic diagram of a conventional TAS. In FIG. 1, the TAS includes multiple functional elements such as a TAS client, a storefront, a developer support and a capability resources management. The detailed functions of the TAS client, the storefront, the developer support and the capability resources management are illustrated as follows.

First, the TAS client is utilized for browsing and downloading the applications provided by the storefront, and interacting with the storefront, to maintain an installation status of a downloaded application. The TAS client can deliver capability information of the device to the storefront by using existed transport protocols (e.g. HTTP User Agent Profile) when the TAS client requests to browse the applications. The storefront is utilized for providing applications to a user, and the user can download the applications by the TAS client embedded in the phone or installed in a computer system or an entrance network. Please note that, the application has to pass an audited procedure at the developer support, before the application is public by the storefront to the TAS client. The developer support manages the applications uploaded by the developers, and audits the uploaded applications and related information thereof. The capability resources management manages information related to the capability resources including the network resources and internet resources. The abovementioned resources can register at the capability resources management by utilizing related information. Besides, the capability resources management can provide register resources information to other elements.

In current specification of the TAS, there are at least six states of the application, which are offline, online, submitted, audited, tested and end states. A TAS enabler such as the developer support and/or the storefront can manage different states of the application. However, according to the specification of the TAS, it does not specify a method of application state flow control, and thus the TAS enabler supporting the application state flow control cannot realize state transition control of the application.

### SUMMARY OF THE INVENTION

It is therefore an object to provide a method of application state flow control in Telco's application store in order to solve above problem.

A method of application state flow control for a developer support in Telco's application store developed by Open Mobile Alliance is disclosed. The method comprises transferring a state of an application between offline, online, submitted, audited, tested and end states according to an operation corresponding to the application and an application developer, wherein the operation comprises at least one of upload procedure, audited procedure, test procedure, delete or revocation procedure, registration procedure, and de-registration procedure.

A method of application state flow control for an application storefront in Telco's application store developed by Open Mobile Alliance is disclosed. The method comprises transferring a state of an application between offline, online and invalidated states according to an operation corresponding to the application, wherein the operation comprises at least one of verification procedure, publication procedure and delete or revocation procedure.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a conventional Telco's Application Store (TAS).

FIG. 2 is a schematic diagram of a service system according to an embodiment of the present invention.

FIG. 3 is a schematic diagram of a communication device according to an embodiment of the present invention.

FIG. 4 is a flowchart of a process according to an embodiment of the present invention.

FIG. 5 is a schematic diagram of an application state transition according to an embodiment of the present invention.

FIG. 6 is a flowchart of a process according to an embodiment of the present invention.

FIG. 7 is a schematic diagram of an application state transition according to an embodiment of the present invention.

### DETAILED DESCRIPTION

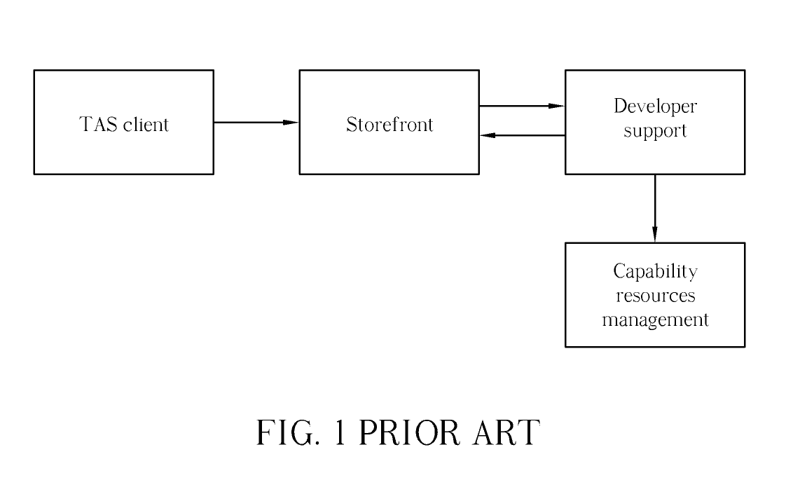

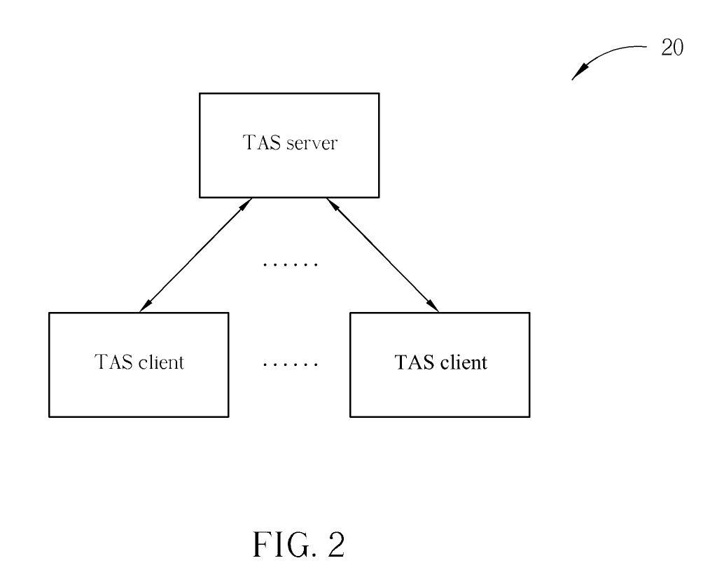

Please refer to FIG. 2, which is a schematic diagram of a service system 20 according to an embodiment of the present invention. The service system 20 complies with an Open Mobile Alliance (OMA) Telco's Application Store (TAS) protocol and is briefly composed of a TAS server and a TAS client. The TAS server includes a storefront, a developer support and a capability resources management shown in FIG. 1. The TAS server provides different applications for a user of a TAS client to download. The TAS client can be a mobile phone, a computer or a music player, etc. Categories of the applications can include game, travel, product, entertainment, book, education, etc, wherein each of the applications can be free or not.

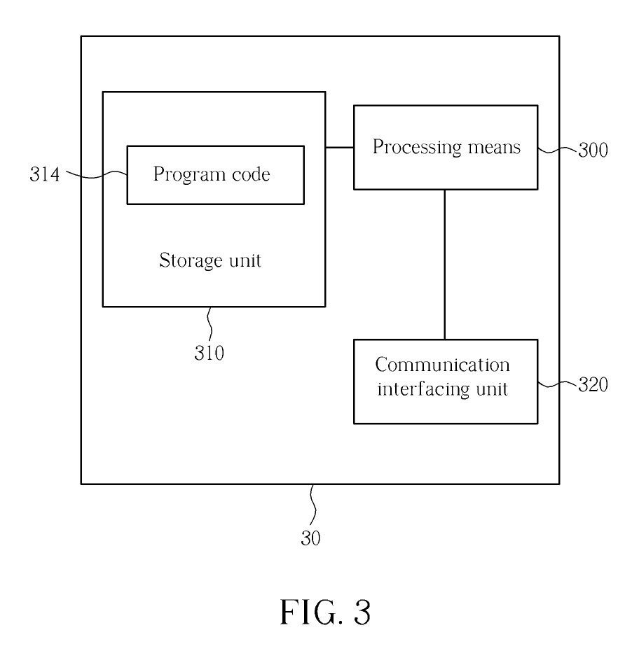

Please refer to FIG. 3, which is a schematic diagram of a communication device 30 according to an embodiment of the present invention. The communication device 30 can be the TAS server or the TAS client shown in FIG. 2. The communication device 30 may include a processing means 300 such as a microprocessor or Application Specific Integrated Circuit (ASIC), a storage unit 310 and a communication interfacing unit 320. The storage unit 310 may be any data storage device that can store a program code 314, accessed by the processing means 300. Examples of the storage unit 310 include but are not limited to a subscriber identity module (SIM), read-only memory (ROM), flash memory, random-access memory (RAM), CD-ROM/DVD-ROM, magnetic tape, hard disk, and optical data storage device. The communication interfacing unit 320 is preferably a transceiver, and can transmit/receive a message according to processing results of the processing means 300.

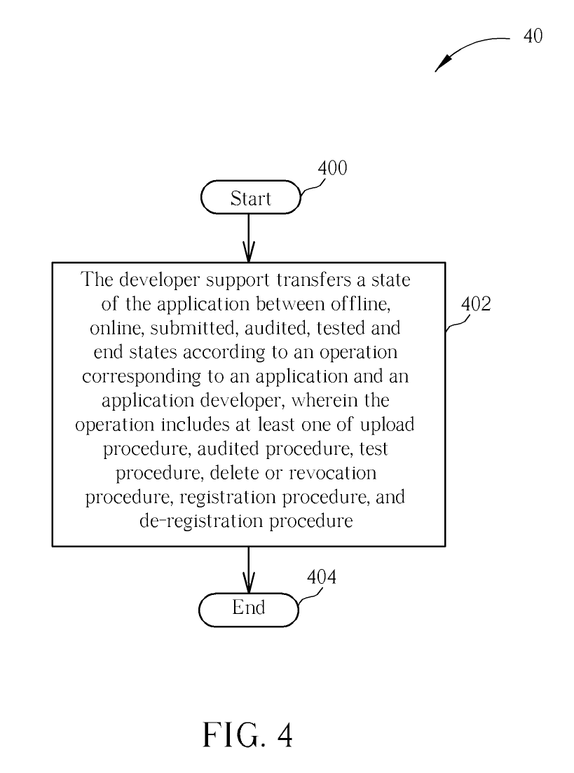

Please refer to FIG. 4, which is a flowchart of a process 40 according to an embodiment of the present invention. The process 40 is utilized for a developer support of the TAS shown in FIG. 1, for controlling state transition of the application in TAS. The states of the application include offline, online, submitted, audited, tested and end states. The process 40 may be compiled into the program code 314 and includes the following steps:

Step 400: Start.

Step 402: The developer support transfers a state of the application between offline, online, submitted, audited, tested and end states according to an operation corresponding to an application and an application developer, wherein the operation includes at least one of upload procedure, audited procedure, test procedure, delete or revocation procedure, registration procedure, and de-registration procedure.

Step 404: End.

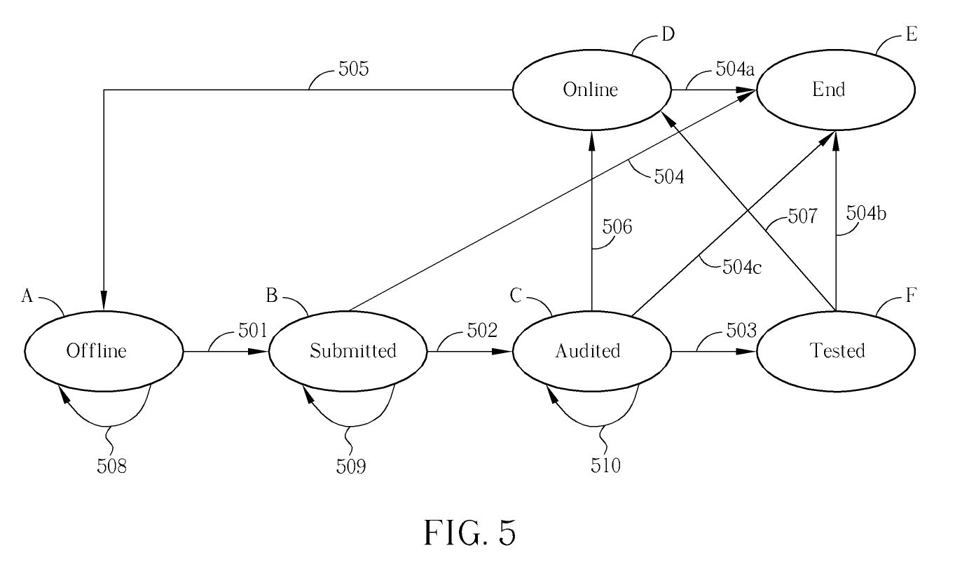

According to the process 40, the upload procedure, the audited procedure, the test procedure, the delete or revocation procedure, the registration procedure, and/or the de-registration procedure may trigger the state transition of the application, such as transferring between the offline, the online, the submitted, the audited, the tested and the end states. In detail, please refer to FIG. 5, which is a schematic diagram of an application state transition according to an embodiment of the present invention. In FIG. 5, the states of the application include offline state A, submitted state B, audited state C, online state D, end state E and tested state F. When the application developer has successfully logged in and registered to the TAS server/TAS service provider, the application developer is permitted to upload the applications and to access to resources. Furthermore, after the application developer uploads the application, the application state is transferred from the offline state A to the submitted state B (step 501). Note that, if the registration procedure or the upload procedure fails, the application may stay in the offline state A (step 508). After the application developer successfully uploads the application, the application is performed with the audited procedure controlled by the TAS service provider's policy, to be transferred from the submitted state B to the audited state C (step 502). Note that, service provider's policy shall provide information for auditing. If the audited procedure of the application fails, the application state is still the submitted state B (step 509). When the uploaded application successfully passes through the audit procedure, the application state is transferred from the audited state C to the online state D (step 506), and the application is published on the storefront for the TAS client to download and purchase. The TAS enabler guarantees that only the application at the online sate D can be downloaded. When the uploaded application is deleted or revoked, the application state is transferred from the online state D to the end state E (step 504a). On the other hand, when the application developer de-registers to the TAS server/TAS service provider, the application state is transferred from the online state D to the offline state A (step 505).

Note that, at the submitted state B, if the application developer deletes or revokes the application before this application enters to the online state D, the application state is transferred from the submitted state B to the end state E (step 504). At the audited state C, if the application developer deletes or revokes the application before this application enters to the online state D, the application state is transferred from the audited state C to the end state E (step 504c). In addition, at the audited state C, the application developer can request to test the uploaded application. If the application passes through the test procedure, the application state is transferred to the tested state F (step 503). If the application does not pass through the test procedure, the application state is still the audited C (step 510). Note that, the test procedure at the state transition of the application is not a mandatory step. When the application successfully passes through the audit procedure and the test procedure, the application state is transferred from the tested state F to the online state D (step 507), and thereby the application is published on the storefront for the TAS client to download and purchase. At the tested state F, if the application developer deletes or revokes the application before this application enters to the online state D, the application state is transferred from the tested state F to the end state E (step 504b). The state transition of the application triggered by operations is well defined according to the embodiment of the present invention.

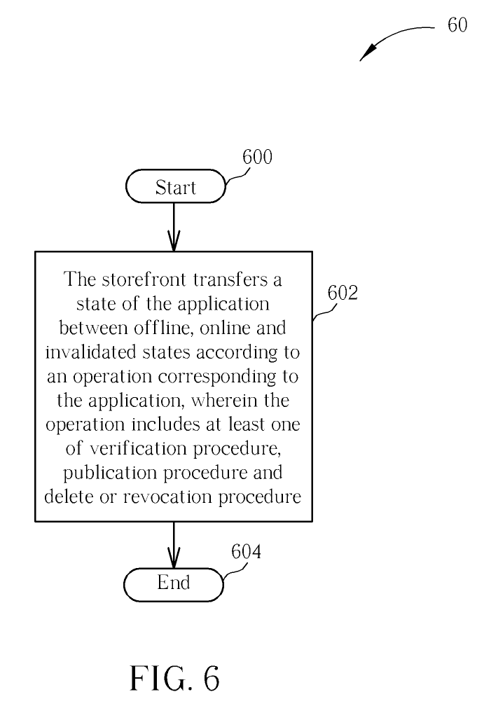

Please refer to FIG. 6, which is a flowchart of a process 60 according to an embodiment of the present invention. The process 60 is utilized for the storefront shown in FIG. 1, for controlling the state transition of the application in TAS. For the storefront, the application includes three states: offline, online and invalidated states. The process 60 may be compiled into the program code 314 and includes the following steps:

Step 600: Start.

Step 602: The storefront transfers a state of the application between offline, online and invalidated states according to an operation corresponding to the application, wherein the operation includes at least one of verification procedure, publication procedure and delete or revocation procedure.

Step 604: End.

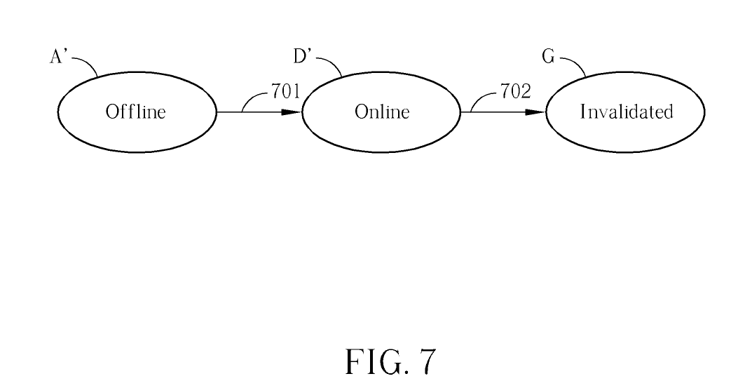

According to the process 60, the verification procedure, the publication procedure or the delete or revocation procedure may trigger the state transition of the application, such as the offline, the online and the invalidated states. In detail, please refer to FIG. 7, which is a schematic diagram of an application state transition according to an embodiment of the present invention. When the uploaded application is successfully verified and the storefront is ready to publish the application on market, the application state is transferred from the offline state A′ to the online state D′ (step 701), for the TAS client to download and purchase. On the other hand, when the application is not allowed to be public and displayed on the storefront, such as an expiration date of the application is expired or withdrawn by the storefront, the application has to be deleted from the storefront by the delete or revocation procedure, and the application state is transferred from the online state D′ to the invalidated state G (step 702). The state transition of the application triggered by operations is well defined according to the embodiment of the present invention.

Please note that, the abovementioned steps of the processes including suggested steps can be realized by means that could be a hardware, a firmware known as a combination of a hardware device and computer instructions and data that reside as read-only software on the hardware device, or an electronic system. Examples of hardware can include analog, digital and mixed circuits known as microcircuit, microchip, or silicon chip. Examples of the electronic system can include a system on chip (SOC), system in package (SiP), a computer on module (COM), and the communication device 30.

To sum up, embodiments of the present invention well define the state transition process of the application of the developer support and the storefront in TAS. In the developer support, the state transition of the application is triggered according to the upload procedure, the audited procedure, the delete or revocation procedure, the registration procedure, the test procedure and/or the de-registration procedure. In the storefront, the state transition of the application is triggered according to the verification procedure and/or the publication procedure. Therefore, the developer support/the storefront can control the state transition of the application.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of application state flow control for a developer support in Telco's application store (TAS) developed by Open Mobile Alliance (OMA), the method comprising:
transferring a state of an application between offline, online, submitted, audited, tested and end states according to an operation corresponding to the application and an application developer;
wherein the operation comprises at least one of upload procedure, audited procedure, test procedure, delete or revocation procedure, registration procedure, and de-registration procedure.

2. The method of claim 1, wherein the step of transferring the state of the application between offline, online, submitted, audited, tested and end states according to the operation corresponding to the application and the application developer comprises:
transferring the state of the application from the offline state to the submitted state when the application is successfully registered and uploaded; and
maintaining the state of the application in the offline state when the application is not successfully uploaded or the application developer does not successfully register to a server or a provider of the TAS.

3. The method of claim 1, wherein the step of transferring the state of the application between offline, online, submitted, audited, tested and end states according to the operation corresponding to the application and the application developer comprises:
transferring the state of the application from the submitted state to the audited state when the application is performed with the audit procedure controlled by the TAS Service Provider or TAS Server's Policy; and
maintaining the state of the application in the submitted state when the application does not pass through the audit procedure.

4. The method of claim 1, wherein the step of transferring the state of the application between offline, online, submitted, audited, tested and end states according to the operation corresponding to the application and the application developer comprises:
transferring the state of the application from the submitted state to the audited state when the application is performed with the audit procedure controlled by the TAS Service Provider or TAS Server's Policy; and
transferring the state of the application from the audited state to the online state when the application successfully passes through the audit procedure.

5. The method of claim 1, wherein the step of transferring the state of the application between offline, online, submitted, audited, tested and end states according to the operation corresponding to the application and the application developer comprises:
transferring the state of the application from the audited state to the end state when the application at the audited state is deleted or revoked.

6. The method of claim 1, wherein the step of transferring the state of the application between offline, online, submitted, audited, tested and end states according to the operation corresponding to the application and the application developer comprises:
transferring the state of the application from the submitted state to the end state when the application at the submitted state is deleted or revoked.

7. The method of claim 1, wherein the step of transferring the state of the application between offline, online, submitted, audited, tested and end states according to the operation corresponding to the application and the application developer comprises:
transferring the state of the application from the online state to the end state when the application at the online state is deleted or revoked.

8. The method of claim 1, wherein the step of transferring the state of the application between offline, online, submitted, audited, tested and end states according to the operation corresponding to the application and the application developer comprises:
transferring the state of the application from the online state to the offline state when the application developer de-registers to the server or the service provider of the TAS.

9. The method of claim 1, wherein the step of transferring the state of the application between offline, online, submitted, audited, tested and end states according to the operation corresponding to the application and the application developer comprises:
transferring the state of the application from the audited state to the tested state when the application is performed with the test procedure; and
maintaining the state of the application in the audited state when the application does not passed through the test procedure.

10. The method of claim 1, wherein the step of transferring the state of the application between offline, online, submitted, audited, tested and end states according to the operation corresponding to the application and the application developer comprises:
transferring the state of the application from the audited state to the tested state when the application is performed with the test procedure; and
transferring the state of the application from the tested state to the online state when the application successfully passes through the test procedure.

11. The method of claim 1, wherein the step of transferring the state of the application between offline, online, submitted, audited, tested and end states according to the operation corresponding to the application and the application developer comprises:
transferring the state of the application from the tested state to the end state when the application at the tested state is deleted or revoked.

12. A method of application state flow control for an application storefront in Telco's application store (TAS) developed by Open Mobile Alliance (OMA), the method comprising:
transferring a state of an application between offline, online and invalidated states according to an operation corresponding to the application;
wherein the operation comprises at least one of verification procedure, publication procedure and delete or revocation procedure.

13. The method of claim 12, wherein the step of transferring the state of the application between offline, online and invalidated states according to the operation corresponding to the application comprises:
transferring the state of the application from the offline state to the online state when the application successfully passes through the verification procedure and the application storefront is ready to publish the application.

14. The method of claim 12, wherein the step of transferring the state of the application between offline, online and invalidated states according to the operation corresponding to the application comprises:
performing the delete or revocation procedure to delete the application from the application storefront and transferring the state of the application from the online state to the invalidated state, when the application is not permitted to be displayed in the application storefront.

15. The method of claim 14, wherein conditions of the application being not permitted to be displayed in the application storefront comprise an expiration date of the application is expired and the application storefront withdraws the application.
